(19) United States
(12) Patent Application Publication
(10) Pub. No.: US 2026/0027939 A1
(43) Pub. Date: Jan. 29, 2026

(54) METHOD

(71) Applicant: TOYOTA JIDOSHA KABUSHIKI KAISHA, Toyota-shi (JP)

(72) Inventors: Xunan QIAN, Koto-ku (JP); Kenichiro Sugihara, Kounosu-shi (JP); Satoshi Naoi, Machida-shi (JP)

(73) Assignee: TOYOTA JIDOSHA KABUSHIKI KAISHA, Toyota-shi (JP)

(21) Appl. No.: 19/223,244

(22) Filed: May 30, 2025

(30) Foreign Application Priority Data
Jul. 29, 2024 (JP) 2024-122534

(51) Int. Cl. B60L 53/68; B60L 53/57; B60L 53/62; G06Q 10/0631

(52) U.S. Cl. CPC B60L 53/68; B60L 53/57; B60L 53/62; G06Q 10/06315

(57) ABSTRACT

A method includes accepting from a user a designation of power supply conditions, determining, based on information on a vehicle at a first point in time, a date and time at which the power supply conditions are predicted to be satisfied as a scheduled power supply date and time, determining an operation plan for a power supply vehicle to supply power to the vehicle at the scheduled power supply date and time, predicting whether the power supply conditions are satisfied at the scheduled power supply date and time based on information on the vehicle at a second point in time that is before arrival of the scheduled power supply date and time and is after determination of the operation plan, and modifying the operation plan to cancel the power supply when the power supply conditions are predicted not to be satisfied at the scheduled power supply date and time.

### CROSS-REFERENCE TO RELATED APPLICATION

This application claims priority to Japanese Patent Application No. 2024-122534, filed on Jul. 29, 2024, the entire contents of which are incorporated herein by reference.

### TECHNICAL FIELD

The present disclosure relates to a method.

### BACKGROUND

Technology for providing a rush power supply service in which a power supply vehicle is dispatched is known. For example, Patent Literature (PTL) 1 discloses that upon receiving a rescue request from an EV running out of power requesting power supply to the EV running out of power, a server notifies the rescue request to the vehicle that supports the same standard as the EV running out of power among multiple vehicles that can supply power to external apparatuses.

### CITATION LIST

### Patent Literature

PTL 1: JP 2022-139845 A

### SUMMARY

A possible method for the rush power supply service is to periodically dispatch a power supply vehicle at the timing when the power supply conditions designated in advance by a user are satisfied, without receiving a request from the user on a case-by-case basis. However, in this method, it is assumed that there may be cases in which the power supply conditions are not satisfied later after the decision to dispatch a power supply vehicle has been made. For example, if the vehicle of the user is too far away from the designated power supply point to return to the power supply point by the scheduled power supply date and time, the power supply vehicle cannot supply power even if the power supply vehicle is dispatched to the power supply point, and the rush power supply service may not be provided efficiently. Thus, there is room for improvement with respect to technology for providing a rush power supply service.

It would be helpful to improve technology for providing a rush power supply service.

A method according to an embodiment of the present disclosure is a method performed by an information processing apparatus used for providing a rush power supply service that dispatches a power supply vehicle to supply power to a vehicle of a user, the method including:
accepting from the user a designation of one or more power supply conditions under which the user requests power supply to the vehicle;
determining, based on information on the vehicle at a first point in time, a date and time at which the one or more power supply conditions are predicted to be satisfied as a scheduled power supply date and time;
determining an operation plan for the power supply vehicle to supply power to the vehicle at the scheduled power supply date and time;
predicting whether the one or more power supply conditions are satisfied at the scheduled power supply date and time based on information on the vehicle at a second point in time that is before arrival of the scheduled power supply date and time and is after determination of the operation plan; and
modifying the operation plan to cancel the power supply to the vehicle in a case in which the one or more power supply conditions are predicted not to be satisfied at the scheduled power supply date and time.

According to an embodiment of the present disclosure, when an operation plan for a power supply vehicle has been determined so that power will be supplied to a vehicle at a scheduled power supply date and time at which power supply conditions are predicted to be satisfied and then the power supply conditions are later predicted not to be satisfied at the scheduled power supply date and time, the power supply to the vehicle is automatically canceled. This reduces the occurrence of inconveniences such as vehicles not being able to be supplied with power because the power supply conditions are not satisfied, even though a power supply vehicle has been dispatched, thus enabling the service provider to provide the rush power supply service efficiently. This can improve technology for providing a rush power supply service.

### BRIEF DESCRIPTION OF THE DRAWINGS

In the accompanying drawings:

FIG. 1 is a diagram illustrating a configuration of a system according to an embodiment of the present disclosure; and

FIG. 2 is a flowchart illustrating operations of an information processing apparatus according to the present embodiment.

### DETAILED DESCRIPTION

An embodiment of the present disclosure will be described below, with reference to the drawings. In the descriptions of the present embodiment, detailed descriptions of the same or corresponding portions are omitted or simplified, as appropriate.

### Outline of Embodiment

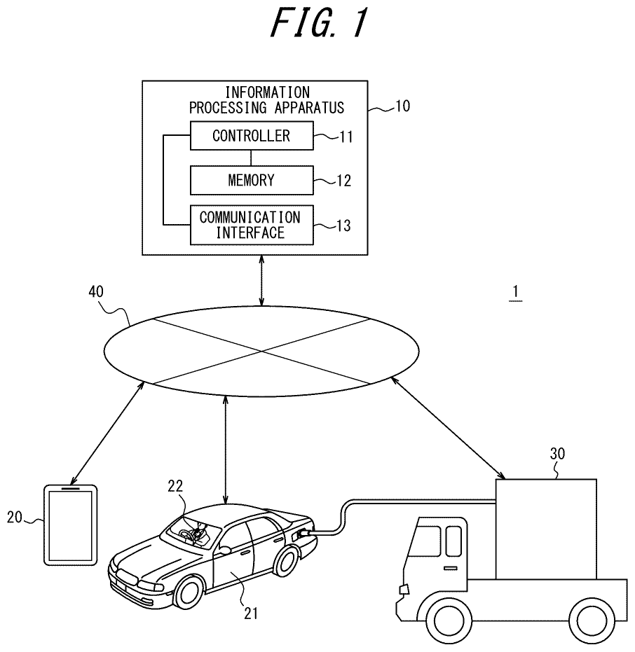

An outline of a system 1 according to the embodiment of the present disclosure will be described with reference to FIG. 1. The system 1 includes an information processing apparatus 10, a terminal apparatus 20, a vehicle 21, and a power supply vehicle 30. The terminal apparatus 20 and the vehicle 21 are used by a user 22. The information processing apparatus 10, the terminal apparatus 20, the vehicle 21, and the power supply vehicle 30 are communicably connected to a network 40 including, for example, the Internet, a mobile communication network, and the like.

The system 1 according to the present embodiment is used to provide so-called rush power supply services. A rush power supply service is a service in which the power supply vehicle 30 goes to the location where the vehicle 21 is located and supplies power to the vehicle 21.

The information processing apparatus 10 is, for example, a server apparatus.

The terminal apparatus 20 is any computer used by the user 22. For example, a general purpose computer such as a smartphone or tablet terminal, or a dedicated computer can be employed as the terminal apparatus 20. Alternatively, the terminal apparatus 20 may be a car navigation system (Automotive navigation system) installed in the vehicle 21 of the user 22.

The power supply vehicle 30 is a vehicle equipped with a storage battery that can supply power to the vehicle 21 by wired or wireless means. The power supply vehicle 30 is, for example, an automobile. The automobile is a Battery Electric Vehicle (BEV), a Hybrid Electric Vehicle (HEV), a Plug-in Hybrid Electric Vehicle (PHEV), a Fuel Cell Electric Vehicle (FCEV), or the like. The power supply vehicle 30 may be operated directly or remotely by the driver. Alternatively, the power supply vehicle 30 may be capable of automated driving such as any one of Level 1 to Level 5 as defined by the Society of Automotive Engineers (SAE), for example. The system 1 may include any number of two or more power supply vehicles 30. In the present embodiment, the power supply vehicle 30 is managed by an operator that provides a rush power supply service.

The network 40 includes the Internet, at least one WAN, at least one MAN, or a combination thereof. The term “WAN” is an abbreviation of wide area network. The term “MAN” is an abbreviation of metropolitan area network. The network 40 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The vehicle 21 is any type of automobile that uses electric power for at least part of its drive, such as a BEV, PHEV, or FCEV.

First, an outline of the present embodiment will be described, and details thereof will be described later. The information processing apparatus 10 accepts from the user 22 a designation of one or more power supply conditions under which the user 22 requests power supply to the vehicle 21. The information processing apparatus 10 determines, based on information on the vehicle 21 at a first point in time, a date and time at which the one or more power supply conditions are predicted to be satisfied as a scheduled power supply date and time. The information processing apparatus 10 determines an operation plan for the power supply vehicle 30 to supply power to the vehicle 21 at the scheduled power supply date and time. The information processing apparatus 10 predicts whether the one or more power supply conditions are satisfied at the scheduled power supply date and time based on information on the vehicle 21 at a second point in time that is before arrival of the scheduled power supply date and time and is after determination of the operation plan. The information processing apparatus 10 then modifies the operation plan to cancel the power supply to the vehicle 21 if the one or more power supply conditions are predicted not to be satisfied at the scheduled power supply date and time.

Thus, according to the present embodiment, when the operation plan for the power supply vehicle 30 has been determined so that power will be supplied to the vehicle 21 at the scheduled power supply date and time at which the power supply conditions are predicted to be satisfied and then the power supply conditions are later predicted not to be satisfied at the scheduled power supply date and time, the power supply to the vehicle 21 is automatically canceled. This reduces the occurrence of inconveniences such as the vehicle 21 not being able to be supplied with power because the power supply conditions are not satisfied, even though the power supply vehicle 30 has been dispatched, thus enabling the service provider to provide the rush power supply service efficiently. This can improve technology for providing a rush power supply service.

### (Configuration of Information Processing Apparatus)

Referring to FIG. 1, the information processing apparatus 10 of the system 1 is described in detail. The information processing apparatus 10 includes a controller 11, a memory 12, and a communication interface 13.

The controller 11 includes at least one processor, at least one programmable circuit, at least one dedicated circuit, or a combination of these. The processor is, for example, a general purpose processor such as a Central Processing Unit (CPU) or a Graphics Processing Unit (GPU), or a dedicated processor that is dedicated to a specific process. The programmable circuit is, for example, a Field-Programmable Gate Array (FPGA). The dedicated circuit is, for example, an Application Specific Integrated Circuit (ASIC). The controller 11 controls operations of the entire information processing apparatus 10.

The memory 12 includes one or more memories. The memories are, for example, semiconductor memories, magnetic memories, optical memories, or the like. The memories included in the memory 12 may each function as, for example, a main memory, an auxiliary memory, or a cache memory. The memory 12 stores any information used for operations of the information processing apparatus 10. For example, the memory 12 may store a system program, an application program, embedded software, and the like. The information stored in the memory 12 may be updated with, for example, information acquired from the network 40 via the communication interface 13.

The communication interface 13 includes at least one interface for communication for connecting to the network 40. The communication interface is compliant with a mobile communication standard such as the 4th generation (4G) standard or the 5th generation (5G) standard, a wired local area network (LAN) standard, a wireless LAN standard, or the like, for example.

### (Flow of Operations of Information Processing Apparatus)

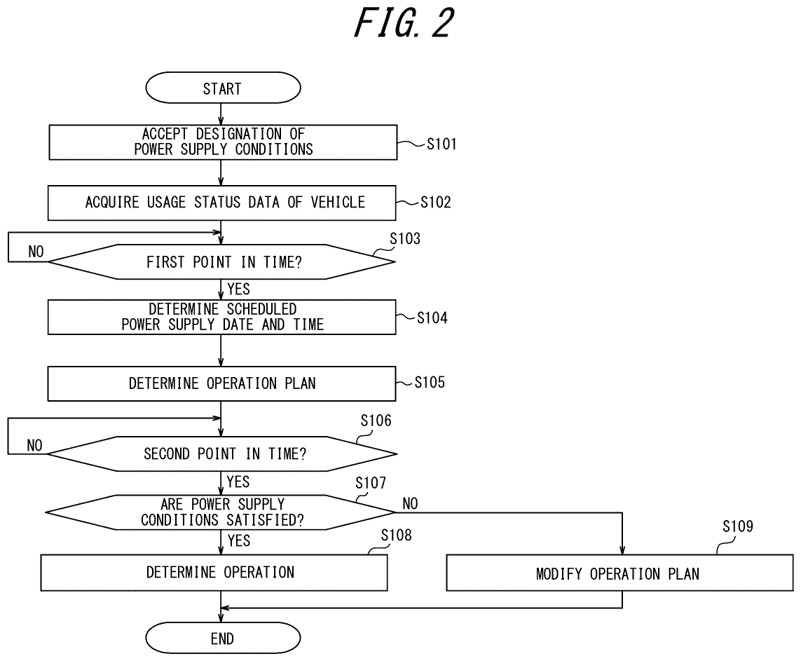

Operations of the information processing apparatus 10 according to the present embodiment will be described with reference to FIG. 2. These operations correspond to a method according to the present embodiment. The information processing apparatus 10 is described below as transmitting and receiving information to and from each apparatus via the communication interface 13 and the network 40.

S101: The controller 11 of the information processing apparatus 10 accepts from the user 22 a designation of one or more power supply conditions under which the user 22 requests power supply to the vehicle 21. Specifically, the user 22 operates the terminal apparatus 20 and enters one or more power supply conditions into the terminal apparatus 20 that request power supply to the vehicle 21. The one or more power supply conditions include a first condition indicating that the remaining battery capacity of the vehicle 21 is within a designated numerical value range, a second condition indicating that the designated power supply date and time is a designated day of week and time of day, and a third condition indicating that the vehicle 21 is located at a designated power supply point. The “numerical value range of the remaining battery capacity” is the range in which power supply to the vehicle 21 is requested while the remaining battery capacity of the vehicle 21 is within the numerical value range. Of the numerical value range, the user 22 may designate only the lower limit, and the upper limit may be set by the operator. The “power supply day of week” is the day of the week when power can be supplied to the vehicle 21. The “power supply time of day” is the time of day at which power can be supplied to the vehicle 21. The “power supply point” is the location where power supply can be supplied to the vehicle 21. Typically, the user 22 may designate the day of week, the time of day, and the location where it is likely that he/she is not using the vehicle 21 and is parked at a specific location as the “power supply day of week”, the “power supply time of day”, and the “power supply point”, respectively. The terminal apparatus 20 transmits power supply condition data indicating one or more power supply conditions to the information processing apparatus 10. The communication interface 13 of the information processing apparatus 10 receives the transmitted power supply condition data. For example, if the user 22 requests that power be supplied to the vehicle 21 at his/her home parking lot in Hachioji City, Tokyo, between 10:00 and 15:00 on Mondays or Wednesdays when the remaining battery capacity of the vehicle 21 is within the range of 20% to 30%, he/she inputs these conditions to the terminal apparatus 20 as power supply conditions.

S102: The controller 11 of the information processing apparatus 10 acquires, via the communication interface 13, usage status data indicating the usage status of the vehicle 21. The usage status data is time-series data of the remaining battery capacity of the vehicle 21, but may also include time-series data such as the travel distance of the vehicle 21. The usage status data is acquired daily at midnight, but any timing can be adopted.

S103: The controller 11 of the information processing apparatus 10 determines whether it is a first point in time. The first point in time is, for example, midnight. At the first point in time, the process proceeds to S104. The process repeats S103 until the first point in time is determined.

S104: The controller 11 of the information processing apparatus 10 determines the date and time when one or more power supply conditions are predicted to be satisfied based on the information on the vehicle 21 at the first point in time as the scheduled power supply date and time. The scheduled power supply date and time includes the power supply date and time and the power supply point. Specifically, the controller 11 predicts the remaining battery capacity of the vehicle 21 for each day based on the usage status indicated by the usage status data acquired in S102. The controller 11 predicts one or more dates for which the predicted remaining battery capacity is within the numerical value range of the remaining battery capacity for the power supply condition (in this case, the first condition). The controller 11 determines the latest date and time that satisfies one or more power supply conditions (in this case, the second condition) among the one or more predicted dates as the scheduled power supply date and time. For example, the controller 11 predicts that the dates when the predicted remaining battery capacity of the vehicle 21 is within the range of 20% to 30% are Monday, April 8 through Wednesday, April 10. The controller 11 determines the Wednesday of April 10, which is the Monday or Wednesday designated in the power supply condition (the second condition) and is the latest date and time among those three dates predicted, as the scheduled power supply date and time.

S105: The controller 11 of the information processing apparatus 10 determines an operation plan for the power supply vehicle 30 to supply power to the vehicle 21 at the scheduled power supply date and time determined in S104. For example, the controller 11 determines an operation plan to supply power to the vehicle 21 at the power supply point in Hachioji City, Tokyo, on Wednesday, April 10, from 10:00 to 12:00.

S106: The controller 11 of the information processing apparatus 10 determines whether it is a second point in time. The second point in time is the point in time that is before arrival of the scheduled power supply date and time and is after determination of the operation plan. The second point in time is, for example, 6:00 a.m. on the day of the power supply date and time. The second point in time may be set at multiple points in time between midnight of the day of the scheduled power supply date and time and the scheduled departure date and time of the power supply vehicle 30. At the second point in time, the process proceeds to S107. The process repeats S106 until a second point in time is determined.

S107: The controller 11 of the information processing apparatus 10 predicts, based on the information on the vehicle 21 at the second point in time, whether one or more power supply conditions are satisfied at the scheduled power supply date and time. If one or more power supply conditions are predicted to be satisfied, the process proceeds to S108. If it is predicted that one or more power supply conditions are not satisfied, the process proceeds to S109. The controller 11 may monitor the remaining battery capacity of the vehicle 21 from the determination of the operation plan until the arrival of the scheduled power supply date and time. The controller 11 may then predict that the first condition are not satisfied at the scheduled power supply date and time if the remaining battery capacity at the second point in time is outside the numerical value range designated in the first condition, and predict that one or more power supply conditions are not satisfied. However, if the remaining battery capacity at the second point in time is below the numerical value range designated in the first condition, the controller 11 may predict that the first condition is satisfied. For example, if the remaining battery capacity of the vehicle 21 is 90% at midnight on Wednesday, April 10, the controller 11 may predict that the first condition is not satisfied at the scheduled power supply date and time. The controller 11 may also monitor the positional information for the vehicle 21 during a time period from the determination of the operation plan until the arrival of the scheduled power supply date and time. The controller 11 may then predict that one or more power supply conditions are not satisfied if the positional information for the vehicle 21 at the second point in time is different from the positional information for the power supply point designated in the third condition, predicting that the third condition is not satisfied at the scheduled power supply date and time. For example, if the positional information for the vehicle 21 indicates Hokkaido as of midnight on Wednesday, April 10, the controller 11 may predict that the third condition will not be satisfied at the scheduled power supply date and time and that one or more power supply conditions are not satisfied. Alternatively, the controller 11 may execute a route search with the position of the vehicle 21 at the second point in time as the starting point and the power supply point designated by the third condition as the destination, and if the predicted arrival time at the destination is later than the scheduled power supply date and time, it may predict that the third condition is not satisfied at the scheduled power supply date and time.

S108: The controller 11 of the information processing apparatus 10 determines the operation of the power supply vehicle 30. The power supply vehicle 30 heads to the power supply point and supplies power to the vehicle 21 according to the operation plan. After S108, the process ends.

S109: The controller 11 of the information processing apparatus 10 modifies the operation plan to cancel the power supply to the vehicle 21. This cancels the dispatch of the power supply vehicle 30 to the vehicle 21. After S109, the process ends.

While the present disclosure has been described with reference to the drawings and examples, it should be noted that various modifications and revisions may be implemented by those skilled in the art based on the present disclosure. Accordingly, such modifications and revisions are included within the scope of the present disclosure. For example, functions or the like contained in each component, each step, or the like can be rearranged without logical inconsistency, and a plurality of components, steps, or the like can be combined into one or a single component, step, or the like can be divided.

For example, in the above embodiment, the controller 11 of the information processing apparatus 10 may inquire of the user 22 a desired power supply date and time and a desired power supply location desired by the user 22. The controller 11 may then remodify the operation plan for the power supply vehicle 30 to supply power to the vehicle 21 at the desired power supply date and time and the desired power supply location.

1. A method performed by an information processing apparatus, the information processing apparatus being used for providing a rush power supply service that dispatches a power supply vehicle to supply power to a vehicle of a user, the method comprising:
accepting from the user a designation of one or more power supply conditions under which the user requests power supply to the vehicle;
determining, based on information on the vehicle at a first point in time, a date and time at which the one or more power supply conditions are predicted to be satisfied as a scheduled power supply date and time;
determining an operation plan for the power supply vehicle to supply power to the vehicle at the scheduled power supply date and time;
predicting whether the one or more power supply conditions are satisfied at the scheduled power supply date and time based on information on the vehicle at a second point in time that is before arrival of the scheduled power supply date and time and is after determination of the operation plan; and
modifying the operation plan to cancel the power supply to the vehicle in a case in which the one or more power supply conditions are predicted not to be satisfied at the scheduled power supply date and time.

2. The method according to claim 1, wherein the one or more power supply conditions include:
a first condition indicating that a remaining battery capacity of the vehicle is within a designated numerical value range;
a second condition indicating that a designated power supply date and time is a designated day of week and time of day; and
a third condition indicating that the vehicle is located at a designated power supply point.

3. The method according to claim 2, wherein the information processing apparatus monitors the remaining battery capacity of the vehicle during a time period from the determination of the operation plan until the arrival of the scheduled power supply date and time, and in a case in which the remaining battery capacity at the second point in time is outside the numerical value range designated in the first condition, predicts that the first condition is not satisfied at the scheduled power supply date and time and modifies the operation plan to cancel the power supply to the vehicle.

4. The method according to claim 2, wherein the information processing apparatus monitors positional information for the vehicle during a time period from the determination of the operation plan until the arrival of the scheduled power supply date and time, and in a case in which the positional information at the second point in time is different from positional information for the power supply point designated in the third condition, predicts that the third condition is not satisfied at the scheduled power supply date and time and modifies the operation plan to cancel the power supply.

5. The method according to claim 1, further comprising:
inquiring of the user, upon canceling the power supply, a desired power supply date and time and a desired power supply location desired by the user; and
remodifying the operation plan for the power supply vehicle to supply power to the vehicle at the desired power supply date and time and the desired power supply location.
